(19) United States
(12) Patent Application Publication
(10) Pub. No.: US 2025/0381956 A1
(43) Pub. Date: Dec. 18, 2025

(54) CONTROL DEVICE FOR VEHICLE, STORAGE MEDIUM, AND CONTROL METHOD

(71) Applicants: TOYOTA JIDOSHA KABUSHIKI KAISHA, Toyota-shi (JP); ADVICS CO., LTD., Kariya-shi (JP)

(72) Inventors: Kazuki MIYAKE, Okazaki-shi (JP); Masumi Dakemoto, Nagoya-shi (JP); Taketsugu Miyata, Toyota-shi (JP); Yusuke Kamiya, Toyota-shi (JP); Sotaro Muramatsu, Tokyo (JP)

(73) Assignees: TOYOTA JIDOSHA KABUSHIKI KAISHA, Toyota-shi (JP); ADVICS CO., LTD., Kariya-shi (JP)

(21) Appl. No.: 19/236,453

(22) Filed: Jun. 12, 2025

(30) Foreign Application Priority Data
Jun. 17, 2024 (JP) 2024-097511

(51) Int. Cl. B60W 30/14

(52) U.S. Cl. CPC B60W 30/143; B60W 2520/105; B60W 2540/10

(57) ABSTRACT

A control device for a vehicle, a storage medium, and a control method are provided. Processing circuitry is configured to receive a requested acceleration from a driver-assistance system of a vehicle and determine an initial acceleration. The initial acceleration is a starting point for modifying a vehicle acceleration toward the requested acceleration. The processing circuitry is configured to generate a transition acceleration that connects the initial acceleration to the requested acceleration and output, based on the transition acceleration, an instruction signal that is used to control an actuator of the vehicle.

### CROSS-REFERENCE TO RELATED APPLICATIONS

This application is based upon and claims the benefit of priority from Japanese Patent Application No. 2024-097511, filed on Jun. 17, 2024, the entire contents of which are incorporated herein by reference.

### BACKGROUND

### 1. Field

The present disclosure relates to a control device for a vehicle, a storage medium, and a control method.

### 2. Description of Related Art

Japanese Laid-Open Patent Publication No. 2020-32894 discloses a control device that serves as a motion manager. When receiving a requested acceleration from a driver-assistance system, the motion manager outputs a command corresponding to the requested acceleration to an actuator control unit of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a control device for a vehicle. The control device includes processing circuitry configured to receive a requested acceleration from a driver-assistance system of the vehicle. The processing circuitry is configured to determine an initial acceleration. The initial acceleration is a starting point for modifying a vehicle acceleration toward the requested acceleration. The processing circuitry is configured to generate a transition acceleration that connects the initial acceleration to the requested acceleration. The processing circuitry is configured to output, based on the transition acceleration, an instruction signal that is used to control an actuator of the vehicle.

Another aspect of the present disclosure provides a storage medium. The storage medium is a non-transitory computer-readable storage medium that stores a program for causing a processing device to execute a control process. The control process includes receiving a requested acceleration from a driver-assistance system of the vehicle, determining an initial acceleration, generating a transition acceleration that connects the initial acceleration to the requested acceleration, and outputting, based on the transition acceleration, an instruction signal that is used to control an actuator of the vehicle. The initial acceleration is a starting point for modifying a vehicle acceleration toward the requested acceleration.

A further aspect of the present disclosure provides a control method executed by a control device that includes processing circuitry. The control method includes receiving, by the processing circuitry, a requested acceleration from a driver-assistance system of the vehicle, determining, by the processing circuitry, an initial acceleration, generating, by the processing circuitry, a transition acceleration that connects the initial acceleration to the requested acceleration, and outputting, by the processing circuitry, based on the transition acceleration, an instruction signal that is used to control an actuator of the vehicle. The initial acceleration is a starting point for modifying a vehicle acceleration toward the requested acceleration.

The above-described configuration allows the initial acceleration to be set properly. The initial acceleration is used to achieve the requested acceleration that has been received from the driver-assistance system.

When there is a difference between the requested acceleration from the driver-assistance system and the current acceleration of the vehicle, a transition acceleration may be calculated. The transition acceleration gradually changes the vehicle acceleration from the initial acceleration toward the requested acceleration. The motion manager calculates a command for the actuator control unit of the vehicle. If the driver-assistance system recognizes the current acceleration and uses it as the initial acceleration, the current acceleration may not be an optimal initial acceleration. Thus, it is desired that the initial acceleration for achieving the requested acceleration received from the driver-assistance system be set properly. The above-described configuration solves such a problem.

Other features and aspects will be apparent from the following detailed description, the drawings, and the claims.

### BRIEF DESCRIPTION OF THE DRAWINGS

FIG. 1 is a schematic diagram showing the configuration of a vehicle.

FIG. 2 is a functional block diagram that illustrates the basic configuration of the motion manager in the vehicle shown in FIG. 1.

FIG. 3 is a flowchart illustrating the procedure of processes by which the motion manager shown in FIG. 2 determines the initial acceleration.

FIG. 4 is a flowchart illustrating the procedure of processes by which the motion manager shown in FIG. 2 determines the transition acceleration.

FIG. 5 is a diagram illustrating the changes in acceleration in a first comparative example.

FIG. 6 is a diagram illustrating the changes in acceleration in the present embodiment.

FIG. 7 is a diagram illustrating the changes in acceleration in a second comparative example.

FIG. 8 is a diagram illustrating the changes in acceleration in the present embodiment.

FIG. 9 is a diagram illustrating the changes in acceleration in a third comparative example.

FIG. 10 is a diagram illustrating the changes in acceleration in the present embodiment.

FIG. 11 is a diagram illustrating the changes in acceleration in a fourth comparative example.

FIG. 12 is a diagram illustrating the changes in acceleration in the present embodiment.

FIG. 13 is a diagram illustrating the changes in acceleration in a fifth comparative example.

FIG. 14 is a diagram illustrating the changes in acceleration in the present embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Schematic Configuration of Vehicle

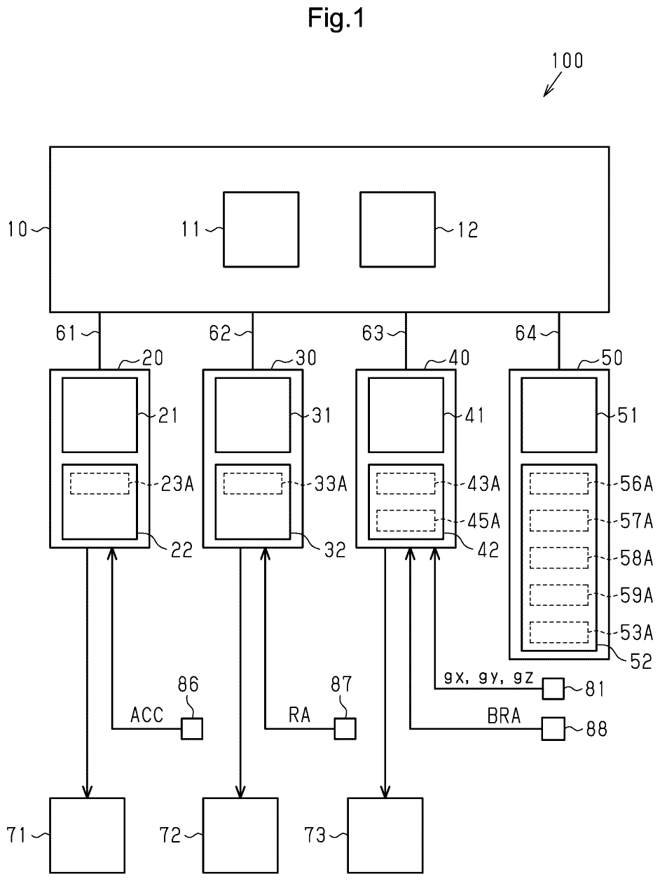

The present disclosure according to an embodiment will now be described with reference to FIGS. 1 to 14. The present embodiment is employed in a control device for a vehicle, a control method, a storage medium, a program, a program product, and a control process. First, the schematic configuration of a vehicle 100 will be described.

As shown in FIG. 1, the vehicle 100 includes a powertrain device 71, a steering device 72, and a brake device 73. In the present embodiment, each of the powertrain device 71, the steering device 72, and the brake device 73 is an actuator of the vehicle 100.

The powertrain device 71 includes, for example, an engine, a motor generator, and a transmission. The engine is configured to transmit driving force to the drive wheels of the vehicle 100 through the transmission. The motor generator is configured to transmit driving force to the drive wheels of the vehicle 100 through the transmission.

The steering device 72 is, for example, a rack-and-pinion electric steering device. The steering device 72 is configured to change the orientation of the steering wheels of the vehicle 100 by controlling the rack and pinion (not shown).

The brake device 73 is a mechanical brake device that mechanically brakes the wheels of the vehicle 100. In the present embodiment, the brake device 73 is, for example, a disc brake.

As shown in FIG. 1, the vehicle 100 includes a central electronic control unit (ECU) 10, a powertrain ECU 20, a steering ECU 30, a brake ECU 40, and an advanced driver-assistance ECU 50. The vehicle 100 includes a first external bus 61, a second external bus 62, a third external bus 63, and a fourth external bus 64.

The central ECU 10 centrally controls the entire vehicle 100. The central ECU 10 includes a central processing device 11 and a central storage device 12. The central processing device 11 is, for example, a central processing unit (CPU). The central storage device 12 includes a read-only memory (ROM), which only allows data to be read, a random-access memory (RAM), which is a volatile memory allowing data to be read and written, and a non-volatile storage, which allows data to be read and written. The central storage device 12 stores various programs, program products, and various types of data in advance. The central processing device 11 is an execution device that executes various processes by executing programs stored in the central storage device 12.

The powertrain ECU 20 is configured to communicate with the central ECU 10 via the first external bus 61. The powertrain ECU 20 controls the powertrain device 71 by outputting control signals to the powertrain device 71. The powertrain ECU 20 includes a powertrain processing device 21 and a powertrain storage device 22. The powertrain processing device 21 is, for example, a CPU. The powertrain storage device 22 includes a ROM, a RAM, and a storage. The powertrain storage device 22 stores various programs and various types of data in advance. Specifically, the powertrain storage device 22 stores a powertrain app 23A in advance as one of the programs. The powertrain app 23A is application software designed to control the powertrain device 71. The powertrain processing device 21 acts as a powertrain control unit 23, which will be described later, by executing the powertrain app 23A stored in the powertrain storage device 22. In the present embodiment, the powertrain ECU 20 is a control device that controls the powertrain device 71.

The steering ECU 30 is configured to communicate with the central ECU 10 via the second external bus 62. The steering ECU 30 controls the steering device 72 by outputting control signals to the steering device 72. The steering ECU 30 includes a steering processing device 31 and a steering storage device 32. The steering processing device 31 is, for example, a CPU. The steering storage device 32 includes a ROM, a RAM, and a storage. The steering storage device 32 stores various programs and various types of data in advance. Specifically, the steering storage device 32 stores a steering app 33A as one of the programs. The steering app 33A is application software designed to control the steering device 72. The steering processing device 31 acts as a steering control unit 33, which will be described later, by executing the steering app 33A stored in the steering storage device 32. In the present embodiment, the steering ECU 30 is a control device that controls the steering device 72.

The brake ECU 40 is configured to communicate with the central ECU 10 via the third external bus 63. The brake ECU 40 controls the brake device 73 by outputting control signals to the brake device 73. The brake ECU 40 includes a brake processing device 41 and a brake storage device 42. The brake processing device 41 is, for example, a CPU. The brake processing device 41 is an example of a processing device or processing circuitry. The brake storage device 42 includes a ROM, a RAM, and a storage. The brake storage device 42 stores various programs and various types of data in advance. Specifically, the brake storage device 42 is an example of a non-transitory computer-readable storage medium that stores the brake app 43A as one of the programs in advance. The brake app 43A is application software designed to control the brake device 73. The brake storage device 42 stores a motion manager app 45A in advance as one of the programs. The motion manager app 45A is application software designed to arbitrate motion requests. The brake processing device 41 acts as a brake control unit 43, which will be described later, by executing the brake app 43A stored in the brake storage device 42. The brake processing device 41 serves as a motion manager 45, which will be described later, by executing the motion manager app 45A stored in the brake storage device 42. In the present embodiment, the brake ECU 40 is a control device. The motion manager app 45A is a control program or a control program product. That is, the brake processing device 41 of the brake ECU 40 executes various processes in the control method by running the motion manager app 45A. The brake ECU 40 is a control device that controls the brake device 73.

The advanced driver-assistance ECU 50 is configured to communicate with the central ECU 10 via the fourth external bus 64. The advanced driver-assistance ECU 50 performs various types of driver assistance functions. The advanced driver-assistance ECU 50 is a computer including an advanced driving processing device 51 and an advanced driving storage device 52. The advanced driving processing device 51 is, for example, a CPU. The advanced driving storage device 52 includes a ROM, a RAM, and a storage. The advanced driving storage device 52 stores various programs and various types of data in advance. The programs include a first assistance app 56A, a second assistance app 57A, a third assistance app 58A, a fourth assistance app 59A, and a preliminary arbitration app 53A. The first assistance app 56A is, for example, application software for an autonomous emergency braking (AEB) system that automatically brakes to mitigate the impact of a collision with the vehicle 100. The second assistance app 57A is, for example, application software for lane keeping assist (LKA) that ensures the vehicle 100 stays in the current lane. The third assistance app 58A is, for example, application software used for adaptive cruise control that follows a preceding vehicle traveling ahead of the vehicle 100 while maintaining a constant distance from the preceding vehicle. The fourth assistance app 59A is, for example, application software for parking assistance that enables automatic parking for the vehicle 100. In the present embodiment, each of the first assistance app 56A, the second assistance app 57A, the third assistance app 58A, and the fourth assistance app 59A is application software that enables the driver assistance functions of the vehicle 100. The advanced driving processing device 51 acts as a first assistance unit 56, which will be described later, by executing the first assistance app 56A stored in the advanced driving storage device 52. The advanced driving processing device 51 acts as a second assistance unit 57, which will be described later, by executing the second assistance app 57A stored in the advanced driving storage device 52. The advanced driving processing device 51 acts as a third assistance unit 58, which will be described later, by executing the third assistance app 58A stored in the advanced driving storage device 52. The advanced driving processing device 51 acts as a fourth assistance unit 59, which will be described later, by executing the fourth assistance app 59A stored in the advanced driving storage device 52. The advanced driving processing device 51 acts as a preliminary arbitration unit 53, which will be described later, by executing the preliminary arbitration app 53A stored in the advanced driving storage device 52. In the present embodiment, the advanced driver-assistance ECU 50 is a control device included in a driver-assistance system. The control of driver assistance executed by the advanced driver-assistance ECU 50 may be referred to as advanced driver-assistance systems (ADAS) control.

The vehicle 100 includes an acceleration sensor 81, an accelerator operation amount sensor 86, a steering angle sensor 87, and a brake operation amount sensor 88.

The acceleration sensor 81 is a three-axis sensor. In other words, the acceleration sensor 81 is configured to detect a front-rear acceleration gx, a left-right acceleration gy, and an up-down acceleration gz.

The front-rear acceleration GX acts along the longitudinal axis of the vehicle 100. The positive value of the front-rear acceleration gx represents an acceleration acting in the driving direction of the vehicle 100. The negative value of the front-rear acceleration gx represents a braking acceleration. The driving acceleration acts in the driving direction of the vehicle 100. The braking acceleration acts in the braking direction of the vehicle 100. In other words, the driving direction of the vehicle 100 is opposite to the braking direction of the vehicle 100. Thus, the value of the front-rear acceleration gx when the driving force of the vehicle 100 is relatively large is greater than the value of the front-rear acceleration gx when the driving force of the vehicle 100 is relatively small. That is, the absolute value of the front-rear acceleration gx when the driving force of the vehicle 100 is relatively large is greater than the absolute value of the front-rear acceleration gx when the driving force of the vehicle 100 is relatively small. In contrast, the value of the front-rear acceleration gx when the braking force of the vehicle 100 is relatively large is smaller than the value of the front-rear acceleration gx when the braking force of the vehicle 100 is relatively small. That is, the absolute value of the front-rear acceleration gx when the braking force of the vehicle 100 is relatively large is greater than the absolute value of the value of the front-rear acceleration gx when the braking force of the vehicle 100 is relatively small.

The left-right acceleration GY acts along the lateral axis of the vehicle 100. The positive value of the left-right acceleration gy represents an acceleration acting leftward on the vehicle 100. The negative value of the left-right acceleration gy represents an acceleration acting rightward on the vehicle 100.

The up-down acceleration GZ acts along the vertical axis of the vehicle 100. The positive value of the up-down acceleration gz represents an acceleration acting upward on the vehicle 100. The negative value of the up-down acceleration gz represents an acceleration acting downward on the vehicle 100. The terms “front,” “rear,” “left,” “right,” “up,” and “down” refer to directions as viewed from the driver's seat of the vehicle 100.

The accelerator operation amount sensor 86 detects an accelerator operation amount ACC, which is the operation amount of the accelerator pedal operated by the driver of the vehicle 100.

The steering angle sensor 87 detects a steering angle RA, which is the angular position of the steering shaft operated by the driver. In the present embodiment, when the steering shaft is in the neutral position, that is, when the vehicle 100 is traveling straight, the steering angle RA is set to a reference position of 0. The steering angle RA when the vehicle 100 is turning left is represented by a positive value. The steering angle RA when the vehicle 100 is turning right is represented by a negative value.

The brake operation amount sensor 88 detects a brake operation amount BRA, which is the operation amount of the brake pedal operated by the driver.

The powertrain ECU 20 acquires a signal indicating the accelerator operation amount ACC from the accelerator operation amount sensor 86. The steering ECU 30 acquires a signal indicating the steering angle RA from the steering angle sensor 87. The brake ECU 40 acquires signals indicating the front-rear acceleration gx, the left-right acceleration gy, and the up-down acceleration gz from the acceleration sensor 81. The brake ECU 40 acquires a signal indicating the brake operation amount BRA from the brake operation amount sensor 88. The brake ECU 40 is configured to acquire various values, including the accelerator operation amount ACC and the steering angle RA, via the central ECU 10.

### Basic Configuration of Motion Manager

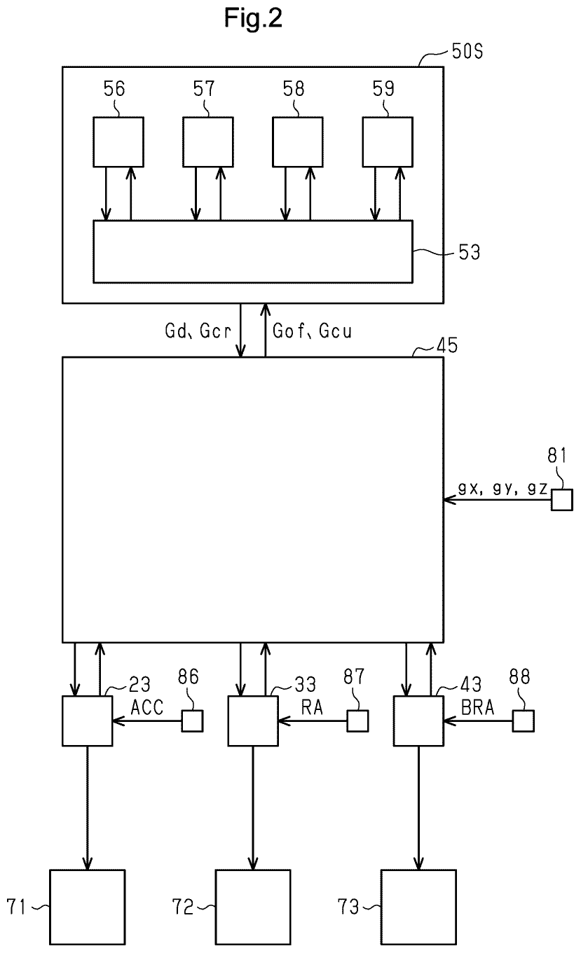

The basic configuration of the motion manager 45 will now be described with reference to FIG. 2. As shown in FIG. 2, the motion manager 45 is configured to communicate with an advanced driver-assistance unit 50S. The motion manager 45 is configured to communicate with the powertrain control unit 23, the steering control unit 33, and the brake control unit 43. The motion manager 45 is configured to acquire, for example, the front-rear acceleration gx. In the present embodiment, the front-rear acceleration gx is an example of the actual acceleration of the vehicle 100.

The advanced driver-assistance unit 50S includes the first assistance unit 56, the second assistance unit 57, the third assistance unit 58, the fourth assistance unit 59, and the preliminary arbitration unit 53.

To execute various controls, the first assistance unit 56, the second assistance unit 57, the third assistance unit 58, and the fourth assistance unit 59 output motion requests to the preliminary arbitration unit 53. The first assistance unit 56, the second assistance unit 57, the third assistance unit 58, and the fourth assistance unit 59 each continue to output the motion request from when the controls become necessary to when the controls are no longer needed. The motion request includes, for example, a requested acceleration Gd to control the front-rear acceleration gx.

The preliminary arbitration unit 53 receives the requested acceleration Gd and the like as motion requests from the first assistance unit 56, the second assistance unit 57, the third assistance unit 58, and the fourth assistance unit 59. The preliminary arbitration unit 53 arbitrates the requested acceleration Gd and the like that have been received. For example, when the preliminary arbitration unit 53 receives the requested acceleration Gd from each of the assistance units, the preliminary arbitration unit 53 selects, as the arbitration result, the requested acceleration Gd that was received first. For example, when the preliminary arbitration unit 53 receives the requested acceleration Gd from each of the assistance units, the preliminary arbitration unit 53 selects the smallest requested acceleration Gd as the arbitration result. In this manner, the preliminary arbitration unit 53 arbitrates motion requests in accordance with the rules that are predefined according to the driving condition of the vehicle 100.

The motion manager 45 receives the requested acceleration Gd and the like as motion requests from the arbitration unit 53. The motion manager 45 also receives motion requests from units other than the advanced driver-assistance unit 50S. The motion manager 45 arbitrates various received motion requests according to the rules predefined according to the driving condition of the vehicle 100.

The motion manager 45 generates instruction signals for operation requests to control various actuators based on the selected requested acceleration Gd and the like as the arbitration result. The actuators include the powertrain device 71, the steering device 72, and the brake device 73. For example, when controlling the powertrain device 71, the motion manager 45 outputs the instruction signal of the operation request to the powertrain control unit 23. The powertrain control unit 23 outputs control signals to the powertrain device 71 based on the instruction signal of the operation request. Thus, the instruction signal output by the motion manager 45 is received by a control unit, which corresponds to an actuator that is to be controlled. The actuator is controlled by the control unit.

For example, upon receiving the requested acceleration Gd as a motion request from the preliminary arbitration unit 53, the motion manager 45 determines an initial acceleration Gsp. The initial acceleration Gsp is the starting point for modifying the vehicle acceleration toward the requested acceleration Gd. The motion manager 45 generates a transition acceleration Gc that connects the initial acceleration Gsp to the requested acceleration Gd. The motion manager 45 controls various actuators of the vehicle 100 based on the transition acceleration Gc. That is, the motion manager 45 calculates an accelerator-off acceleration Gof. The accelerator-off acceleration Gof is the vehicle acceleration Gcu when the accelerator pedal operated by the vehicle driver is released. The accelerator-off acceleration Gof is calculated based on, for example, the engine rotation speed that has been obtained by the motion manager 45 from the powertrain control unit 23, the gear ratio of the transmission, and the gradient of the road surface on which the vehicle 100 is traveling. When the transition acceleration Gc is greater than or equal to the accelerator-off acceleration Gof, the motion manager 45 calculates the driving force to achieve the transition acceleration Gc. The motion manager 45 outputs the calculated driving force to the powertrain control unit 23 as an instruction signal for an operation request to control the powertrain device 71. When the transition acceleration Gc is less than the accelerator-off acceleration Gof, the motion manager 45 calculates the braking force to achieve the transition acceleration Gc. The motion manager 45 outputs the calculated braking force to the brake control unit 43 as an instruction signal for an operation request to control the brake device 73. The motion manager 45 outputs the accelerator-off acceleration Gof to the advanced driver-assistance unit 50S.

Each of the powertrain control unit 23, the steering control unit 33, and the brake control unit 43 is configured to receive an instruction signal for an operation request not only from the motion manager 45 but also from the driver of the vehicle 100. The powertrain control unit 23 is configured to receive the accelerator operation amount ACC, which is detected by the accelerator operation amount sensor 86, as an instruction signal for an operation request to control the actuator based on the driver's operation. The steering control unit 33 is configured to receive the steering angle RA, which is detected by the steering angle sensor 87, as an instruction signal for an operation request to control the actuator based on the driver's operation. The brake control unit 43 is configured to receive the brake operation amount BRA, which is detected by the brake operation amount sensor 88, as an instruction signal for an operation request to control the actuator based on the driver's operation.

Upon receiving the instruction signal for the operation request from the driver of the vehicle 100, each of the powertrain control unit 23, the steering control unit 33, and the brake control unit 43 outputs a control signal to the actuator based on the magnitude of the instruction signal from the driver.

For example, when an accelerator acceleration Gac is greater than or equal to the transition acceleration Gc or the requested acceleration Gd, the powertrain device 71 is controlled to obtain the driving force to achieve the accelerator acceleration Gac. The accelerator acceleration Gac is a value calculated based on, for example, the accelerator operation amount ACC. The accelerator acceleration Gac indicates the magnitude of the acceleration acting in the driving direction currently requested by the driver. When the accelerator acceleration Gac is less than the transition acceleration Gc or the requested acceleration Gd, the powertrain device 71 is controlled to obtain the driving force to achieve the transition acceleration Gc or the requested acceleration Gd.

For example, when a braking acceleration Gbr is less than or equal to the transition acceleration Gc or the requested acceleration Gd, the brake device 73 is controlled to obtain the braking force to achieve the brake deceleration Gbr. The value of the braking acceleration Gbr is calculated based on, for example, the brake operation amount BRA. The value of the braking acceleration Gbr indicates the magnitude of the braking acceleration currently requested by the driver. When the braking acceleration Gbr is less than or equal to the transition acceleration Gc or the requested acceleration Gd, the absolute value of the braking acceleration Gbr is greater than or equal to the absolute value of the transition acceleration Gc or the absolute value of the requested acceleration Gd. In other words, the braking force corresponding to the braking acceleration Gbr is greater than or equal to the braking force corresponding to the transition acceleration Gc or the requested acceleration Gd.

When the braking acceleration Gbr is less than or equal to the transition acceleration Gc or the requested acceleration Gd, the brake device 73 is controlled to obtain the braking force to achieve the transition acceleration Gc or the requested acceleration Gd. When the braking acceleration Gbr is greater than the transition acceleration Gc or the requested acceleration Gd, the absolute value of the braking acceleration Gbr is less than the absolute value of the transition acceleration Gc or the absolute value of the requested acceleration Gd. In other words, the braking force corresponding to the braking acceleration Gbr is less than the braking force corresponding to the transition acceleration Gc or the requested acceleration Gd.

### Setting of the Initial Acceleration

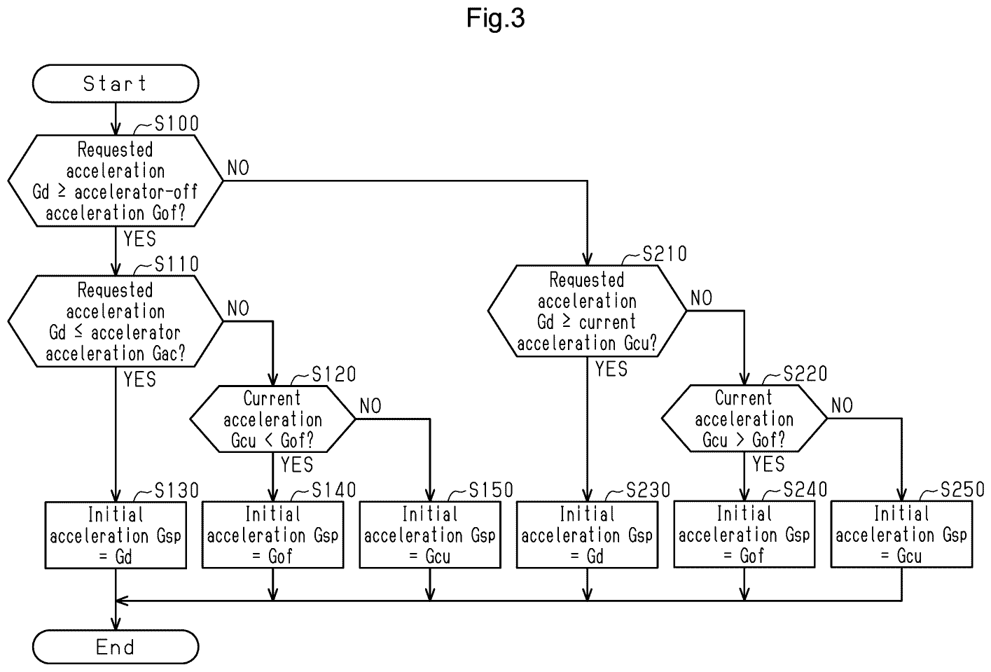

FIG. 3 illustrates the procedure of processes executed by the motion manager 45 to determine the initial acceleration Gsp. These processes are repeatedly executed by the brake ECU 40 at predetermined cycles when an ADAS request flag F turns ON. The brake ECU 40 implements the motion manager 45. The advanced driver-assistance ECU 50, which implements the advanced driver-assistance unit 50S, sets the ADAS request flag F. When a motion request through ADAS control is issued, the ADAS request flag F is set to ON. When the motion request from the ADAS control is eliminated, the ADAS request flag F is set to OFF.

In the following description, the number of each step is represented by the letter S followed by a numeral.

Upon initiating the present process, the motion manager 45 determines whether the requested acceleration Gd that has been received from the advanced driver-assistance unit 50S is greater than or equal to the currently calculated accelerator-off acceleration Gof (S100). When the requested acceleration Gd is the acceleration acting in the driving direction, the process in S100 results in an affirmative determination. The driving acceleration includes the acceleration acting in the driving direction of the vehicle 100. When the requested acceleration Gd is the braking acceleration, the process in step S100 results in a negative determination. The braking acceleration acts in the braking direction of the vehicle 100.

When the process in step S100 results in an affirmative determination, the motion manager 45 determines whether the requested acceleration Gd is less than or equal to the accelerator acceleration Gac (S110). The motion manager 45 calculates the value of the accelerator acceleration Gac based on, for example, the accelerator operation amount ACC. The value of the accelerator acceleration Gac indicates the acceleration acting in the driving direction currently requested by the driver.

When the requested acceleration Gd is determined as being less than or equal to the accelerator acceleration Gac in the process of S110 (S110: YES), the motion manager 45 substitutes the requested acceleration Gd that has been received from the advanced driver-assistance unit 50S into the initial acceleration Gsp (S130).

When the requested acceleration Gd is greater than the accelerator acceleration Gac and thus the process of S110 is determined as being negative, the motion manager 45 determines whether a current acceleration Gcu of the vehicle 100 is less than the accelerator-off acceleration Gof (S120). The value of the current acceleration Gcu is obtained by the motion manager 45 executing a process that converts, into an acceleration, the current driving force obtained from the powertrain control unit 23 and the current braking force obtained from the brake control unit 43. That is, the value of the current acceleration Gcu indicates the front-rear acceleration currently acting on the vehicle 100. When the current acceleration Gcu of the vehicle 100 is the acceleration acting in the braking direction of the vehicle 100, the process of step S120 is determined as being affirmative. When the current acceleration Gcu of vehicle 100 acts in the driving direction, the process of step S120 is determined as being negative. The motion manager 45 outputs the current acceleration Gcu to the advanced driver-assistance unit 50S.

When the process of step S120 results in an affirmative determination, the motion manager 45 substitutes the accelerator-off acceleration Gof into the initial acceleration Gsp (S140).

When the process of step S120 results in a negative determination, the motion manager 45 substitutes the current acceleration Geu into the initial acceleration Gsp (S150).

When the process in step S100 results in a negative determination, the motion manager 45 determines whether the requested acceleration Gd is greater than or equal to the current acceleration Gcu (S210). Since the process of S100 results in a negative determination, the requested acceleration Gd in S210 is the acceleration acting in the braking direction of the vehicle 100. When the requested acceleration Gd acting in the braking direction is greater than or equal to the current acceleration Gcu, the following relationship applies. The current acceleration Gcu is the acceleration acting in the braking direction of the vehicle 100. The value of the braking force corresponding to the requested acceleration Gd is equivalent to or smaller than the value of the braking force corresponding to the current acceleration Gcu. The absolute value of the requested acceleration Gd is less than the absolute value of the current acceleration Gcu.

When the requested acceleration Gd is determined as being greater than or equal to the current acceleration Gcu in the process of S210 (S210: YES), the motion manager 45 substitutes the requested acceleration Gd that has been received from the advanced driver-assistance unit 50S into the initial acceleration Gsp (S230).

When the requested acceleration Gd is less than the current acceleration Gcu and thus the process of S210 is determined as being negative, the motion manager 45 determines whether the current acceleration Gcu is less than the accelerator-off acceleration Gof (S220). When the current front-rear acceleration of the vehicle 100 is the acceleration acting in the driving direction, the process of step S220 is determined as being affirmative. When the current acceleration of the vehicle 100 is the acceleration acting in the braking direction of the vehicle 100, the process of step S220 is determined as being negative.

When the process of step S220 results in an affirmative determination, the motion manager 45 substitutes the accelerator-off acceleration Gof into the initial acceleration Gsp (S240).

When the process of step S120 results in a negative determination, the motion manager 45 substitutes the current acceleration Gcu into the initial acceleration Gsp (S250).

After executing any one of the processes S130, S140, S150, S230, S240, and S250, the motion manager 45 ends the present process for the current execution cycle.

### Calculation of Transition Acceleration

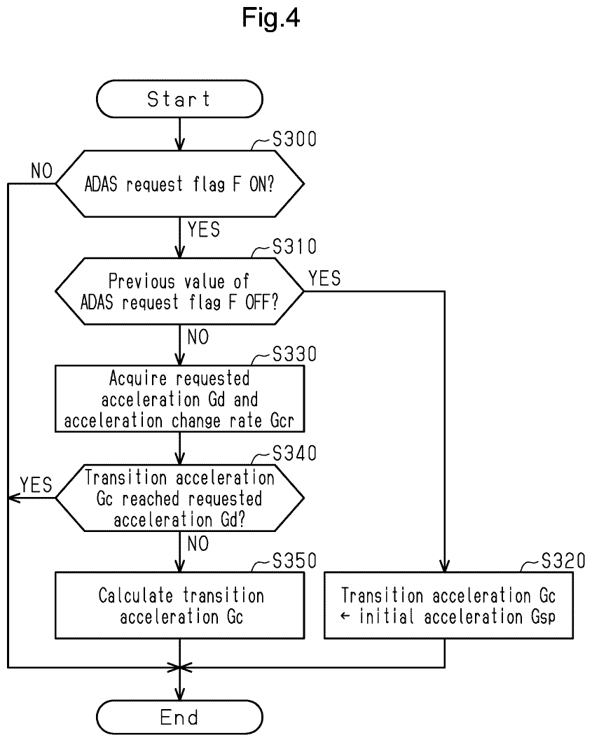

FIG. 4 illustrates the procedure of processes executed by the motion manager 45 to generate the transition acceleration Gc. These processes are repeatedly executed by the brake ECU 40, which implements the motion manager 45, at predetermined execution cycles.

Upon starting the present process, the motion manager 45 determines whether the ADAS request flag Fis ON (S300).

When determining that the ADAS request flag F is ON in the process of S300 (S300: YES), the motion manager 45 determines whether the previous value of the ADAS request flag F was OFF (S310). The previous value of the ADAS request flag F is the value of the ADAS request flag F that the motion manager 45 had already acquired when the present process was executed during the previous execution cycle. In a case in which the execution of the present process is the first execution after the issuance of a driving request through the ADAS control, the following determinations are made. In the current execution cycle, since the value of the ADAS request flag F is ON while the previous value of the ADAS request flag F is OFF, the process in step S310 results in an affirmative determination. In a case in which the present process is executed during the execution of ADAS control, the value of the ADAS request flag F in the current execution cycle and the previous value of the ADAS request flag F are both ON, the process in step S310 results in a negative determination.

When the process of step S310 results in an affirmative determination, the motion manager 45 sets the initial transition acceleration Gc to the initial acceleration Gsp, which has been determined through the series of processes shown in FIG. 3 (step S320).

When the process of S310 results in a negative determination, the motion manager 45 acquires the requested acceleration Gd and an acceleration change rate Ger from the advanced driver-assistance unit 50S (S330).

The acceleration change rate Ger is the amount of change per unit time of the vehicle acceleration and is used to modify the vehicle acceleration toward the requested acceleration Gd. The advanced driver-assistance unit 50S sets an optimal acceleration change rate Ger that has been pre-adapted to motion requests from the first assistance unit 56, the second assistance unit 57, the third assistance unit 58, and the fourth assistance unit 59.

Next, the motion manager 45 determines whether the currently calculated transition acceleration Gc has reached the requested acceleration Gd (S340). When determining that the currently calculated transition acceleration Gc has reached the requested acceleration Gd, the motion manager 45 substitutes the value of the requested acceleration Gd into the initial acceleration Gsp.

When determining that the currently calculated transition acceleration Gc has not reached the requested acceleration Gd in the process of S340 (S340: NO), the motion manager 45 calculates the transition acceleration Gc (S350). In the process of step S350, the motion manager 45 determines the median of three values; namely, a transition acceleration GcA, a transition acceleration GcB, and the requested acceleration Gd. The transition acceleration GcA is calculated using the following equation (1). The transition acceleration GcB is calculated using the following equation (2). The motion manager 45 calculates the transition acceleration Gc by substituting the calculated median into the transition acceleration Gc.

$$GcA = Current value of the transition acceleration Gc + Acceleration change rate Gcr \times Execution cycle of the present process \qquad ( 1 )$$

$$GcB = Current value of the transition acceleration Gc - Acceleration change rate Gcr \times Execution cycle of the present process \qquad ( 2 )$$

When the process of step S340 results in a negative determination, the transition acceleration Gc is updated by executing the process of step S350 at each predetermined execution cycle.

When the process of step S320 or step S350 is executed, when the process of step S300 results in a negative determination, or when the process of step S340 results in an affirmative determination, the motion manager 45 ends the present process of the current execution cycle.

### Operation of the Present Embodiment

### Comparison Between the Present Embodiment and First Comparative Example

First, a first comparative example will be explained. As a prerequisite for the first comparative example, the accelerator pedal is released. The requested acceleration Gd is calculated in the direction in which the driving force increases.

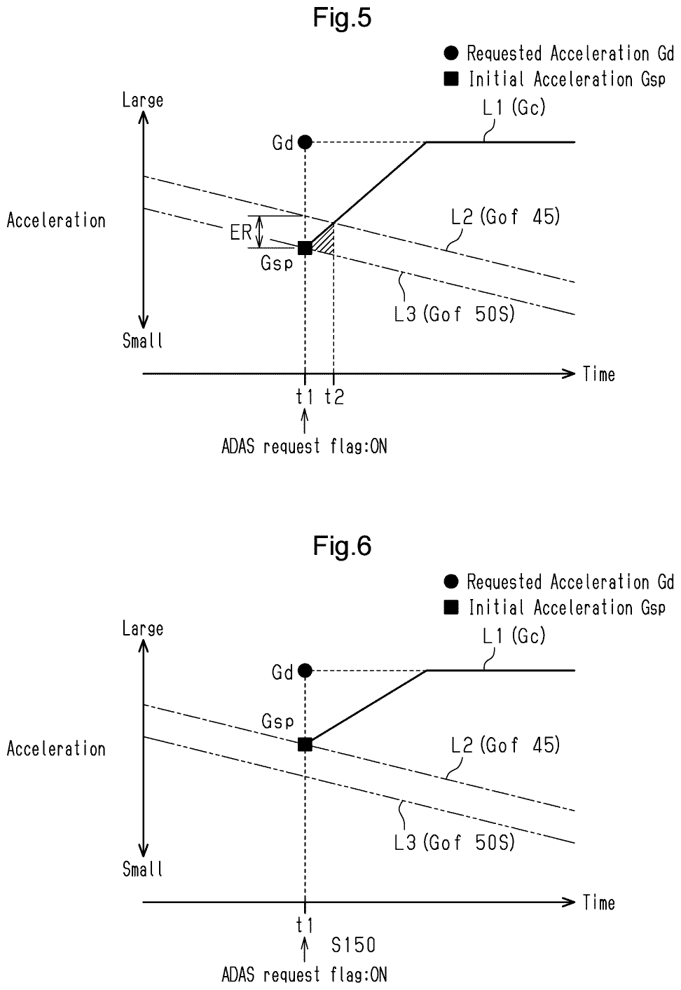

FIG. 5 is a diagram illustrating an example of the changes in acceleration in the first comparative example. The solid line L1 shown in FIG. 5 represents the transition acceleration Gc. The single-dashed line L2 indicates the accelerator-off acceleration Gof recognized by the motion manager 45. The double-dashed line L3 indicates the accelerator-off acceleration Gof recognized by the advanced driver-assistance unit 50S. The value of the accelerator-off acceleration Gof corresponds to the current acceleration Gcu in a state in which the accelerator pedal is released. In FIG. 5, the black circle indicates the requested acceleration Gd. The black square indicates the initial acceleration Gsp.

The first comparative example shown in FIG. 5 executes the following processes to execute ADAS control.

The advanced driver-assistance unit 50S acquires a current value (L3) of the current acceleration Gcu or the accelerator-off acceleration Gof from the motion manager 45 via the third external bus 63 and the fourth external bus 64. The advanced driver-assistance unit 50S sets the initial acceleration Gsp to the current value (L3) of the current acceleration Gcu or the accelerator-off acceleration Gof, which has been acquired from the motion manager 45.

The advanced driver-assistance unit 50S generates the transition acceleration Gc that connects the initial acceleration Gsp to the requested acceleration Gd.

The motion manager 45 receives the transition acceleration Gc, which has been generated by the advanced driver-assistance unit 50S, via the third external bus 63 and the fourth external bus 64.

The motion manager 45 controls the driving force and the braking force of the vehicle 100 based on the transition acceleration Gc, which has been received from the advanced driver-assistance unit 50S.

In the first comparative example, an accelerator-off acceleration Gof_L2, which is recognized by the motion manager 45, is transmitted to the advanced driver-assistance unit 50S via the external buses. In data transmission via the external buses, some level of communication latency may inevitably occur. Consequently, a deviation ER arises between the current value of the accelerator-off acceleration Gof_L2, which is recognized by the motion manager 45, and the current value of an accelerator-off acceleration Gof L3, which is recognized by the advanced driver-assistance unit 50S. Thus, a transition acceleration Gc_L1, which has been received by the motion manager 45, is lower than the accelerator-off acceleration Gof_L2, which is recognized by the motion manager 45, for a period from time t1 to time t2 as shown in FIG. 5. During the period from time t1 to time t2, the brake device 73 can be activated to generate a braking force. Therefore, in the first comparative example, after the braking force is temporarily generated, the driving force increases. This may cause discomfort to the driver.

The present embodiment will now be described.

FIG. 6 illustrates the changes in acceleration in the present embodiment under the same prerequisite as that in the first comparative example. The values indicated by the solid line L1, the single-dashed line L2, and the double-dashed line L3 shown in FIG. 6 are identical to those in FIG. 5.

In the present embodiment, the same prerequisite as that in the first comparative example is satisfied. That is, the accelerator pedal is released. The requested acceleration Gd is calculated in the direction in which the driving force increases. In this case, the process of S100 shown in FIG. 3 results in an affirmative determination. The process of S110 results in a negative determination. Since the process of S120 results in a negative determination, the motion manager 45 executes the process of S150. Accordingly, the motion manager 45 substitutes the current acceleration Gcu into the initial acceleration Gsp. Since the accelerator pedal is currently released, the initial acceleration Gsp to be determined at this stage is equal to the accelerator-off acceleration Gof_L2, which is recognized by the motion manager 45.

Once the initial acceleration Gsp is determined, the motion manager 45 executes the processes shown in FIG. 4. That is, the motion manager 45 generates the transition acceleration Gc based on the requested acceleration Gd and the acceleration change rate Ger that have been received from the advanced driver-assistance unit 50S. The motion manager 45 calculates the driving force to achieve the transition acceleration Gc. The motion manager 45 controls the powertrain device 71 by outputting the calculated driving force as the instruction signal for the operation request to control the powertrain device 71.

In this manner, in the present embodiment, the initial acceleration Gsp is set to a current acceleration Gcu_L2, which is recognized by the motion manager 45. Accordingly, unlike the first comparative example, the deviation ER of the current value of acceleration, which results from communication latency, is reduced. Thus, there is no period during which the transition acceleration Gc_L1 is temporarily lower than the accelerator-off acceleration Gof_L2, which is recognized by the motion manager 45. Therefore, an increase in the driving force generates no temporary braking force. Hence, unlike the first comparative example, the sense of discomfort is prevented from being experienced by the driver.

### Comparison Between the Present Embodiment and Modification of the First Comparative Example

Under the prerequisite of the first comparative example, the requested acceleration Gd has already been calculated in the direction in which the driving force increases. In a case in which the requested acceleration Gd has been calculated in the direction in which the driving force increases, the first comparative example will exhibit behavior opposite to that described above. That is, the transition acceleration Gc_L1, which has been received by the motion manager 45, is greater than the accelerator-off acceleration Gof_L2, which is recognized by the motion manager 45, for a certain period. During this period, a driving force can be generated by the activation of the powertrain device 71. Therefore, after the driving force is temporarily generated, the braking force increases. This may also cause discomfort to the driver.

In the present embodiment, in a state in which the accelerator pedal is released and the requested acceleration Gd has been calculated in the direction of increasing the braking force, the process of step S100 shown in FIG. 3 results in a negative determination. The process of S210 results in a negative determination. Since the process of S220 results in a negative determination, the motion manager 45 executes the process of S250. Accordingly, the motion manager 45 substitutes the current acceleration Gcu into the initial acceleration Gsp. Since the accelerator pedal is currently released, the initial acceleration Gsp to be determined at this stage is equal to the accelerator-off acceleration Gof, which is recognized by the motion manager 45. The motion manager 45 executes the processes shown in FIG. 4 to generate the transition acceleration Gc, starting from the initial acceleration Gsp, and control the braking force of the brake device 73. Thus, in the present embodiment, even in the case in which the accelerator pedal is released and the requested acceleration Gd has been calculated in the direction of increasing the braking force, the initial acceleration Gsp is set to the acceleration recognized by the motion manager 45. As a result, for the same reason as above, an increase in the braking force generates no temporary driving force. Hence, the sense of discomfort is prevented from being experienced by the driver.

### Comparison Between the Present Embodiment and Second Comparative Example

The second comparative example will now be described. As a prerequisite for the second comparative example, the requested acceleration Gd is the acceleration acting in the driving direction. The requested acceleration Gd is less than or equal to the accelerator acceleration Gac. In the second comparative example, the initial acceleration Gsp is set to the current acceleration Gcu. In this regard, the second comparative example differs from the present embodiment.

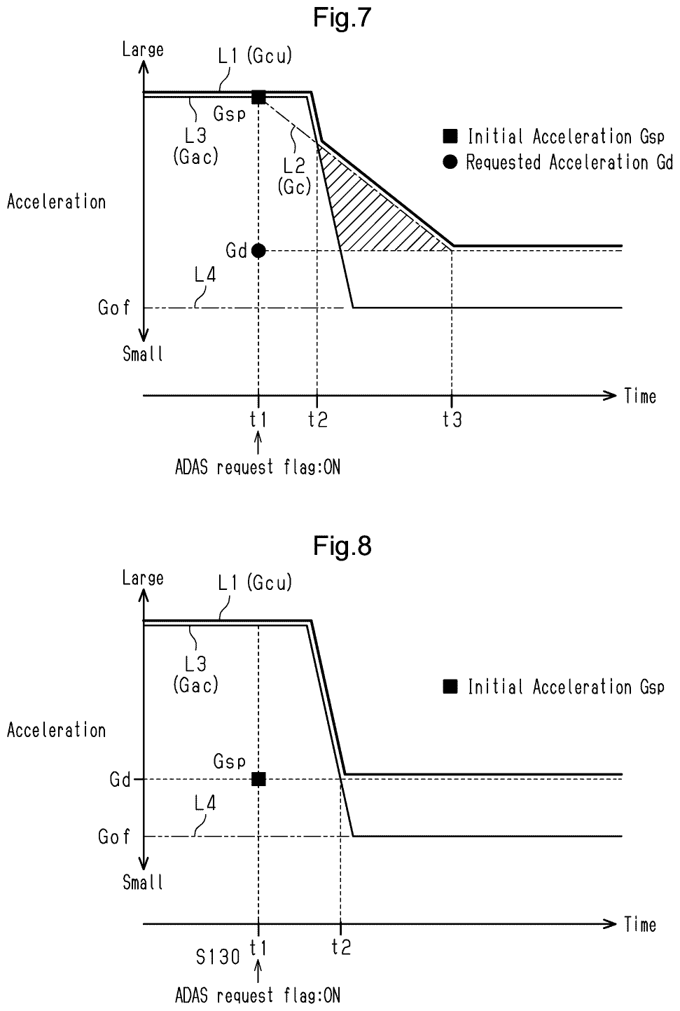

FIG. 7 is a diagram illustrating an example of the changes in acceleration in the second comparative example. The solid line L1 shown in FIG. 7 indicates the current acceleration Gcu. The single-dashed line L2 indicates the transition acceleration Gc. The solid line L3 indicates the accelerator acceleration Gac. The double-dashed line L4 indicates the accelerator-off acceleration Gof. Subsequent to time t3 shown in FIG. 7, the transition acceleration Gc_L2 reaches the requested acceleration Gd. Therefore, the current acceleration Gcu_L1 is controlled to match the requested acceleration Gd.

In this second comparative example, at time t1, the ADAS request flag is turned ON, resulting in the calculation of the requested acceleration Gd. At time t1, the current acceleration Gcu_L1 is substituted into the initial acceleration Gsp. The transition acceleration Gc_L2 is generated from the initial acceleration Gsp toward the requested acceleration Gd.

At a certain point after time t1, when the driver returns the accelerator pedal to a non-operation position, an accelerator acceleration Gac_L3 decreases toward an accelerator-off acceleration Gof_L4.

The following will describe how the accelerator acceleration Gac_L3 decreases. During the period when the accelerator acceleration Gac_L3 is greater than or equal to the transition acceleration Gc_L2, that is, from time t1 to time t2, the powertrain device 71 is controlled to obtain the accelerator acceleration Gac_L3. Thus, the current acceleration Gcu_L1 matches the accelerator acceleration Gac.

The following will further describe how the accelerator acceleration Gac_L3 decreases. During the period when the accelerator acceleration Gac_L3 is less than the transition acceleration Gc_L2, that is, from time t2 to time t3, the powertrain device 71 is controlled to obtain the transition acceleration Gc. Thus, the current acceleration Gcu_L1 matches the transition acceleration Gc_L2. In this manner, during the period from time t2 to time t3, when the powertrain device 71 is controlled, an acceleration greater than the accelerator acceleration Gac_L3 or the requested acceleration Gd occurs even though the driver has returned the accelerator pedal to the non-operation position. Consequently, in the second comparative example, an unnecessary driving force occurs.

The present embodiment will now be described.

FIG. 8 illustrates the changes in acceleration in the present embodiment under the same prerequisite as that in the second comparative example. The values indicated by the solid line L1, the solid line L3, and the double-dashed line L4 shown in FIG. 8 are identical to those in FIG. 7.

In the present embodiment, the same prerequisite as that in the second comparative example is satisfied. That is, the requested acceleration Gd is the acceleration acting in the driving direction. The requested acceleration Gd is less than or equal to the accelerator acceleration Gac. In this case, the processes of S100 and S110 shown in FIG. 3 both result in an affirmative determination. Accordingly, the motion manager 45 executes the process of step S130. Thus, the motion manager 45 substitutes the requested acceleration Gd into the initial acceleration Gsp. That is, in FIG. 8, the black square indicating the initial acceleration Gsp overlaps the black circle indicating the requested acceleration Gd. As a result, in FIG. 8, the black circle indicating the requested acceleration Gd is hidden by the black square indicating the initial acceleration Gsp.

Once the initial acceleration Gsp is determined, the motion manager 45 executes the processes shown in FIG. 4. That is, in step S320 of the present process, the requested acceleration Gd is substituted as the initial value of the transition acceleration Gc. When the present process is executed next time, an affirmative determination will be made in step S340. As a result, the present process ends without executing the process of S350. In other words, the transition acceleration Gc, which connects the initial acceleration Gsp to the requested acceleration Gd, is not substantially generated.

Thus, as shown in FIG. 8, at a certain point after time t1, when the driver returns the accelerator pedal to the non-operation position, the accelerator acceleration Gac_L3 decreases toward the accelerator-off acceleration Gof_L4.

When the accelerator acceleration Gac decreases, the transition acceleration Gc is not generated. Accordingly, during the period when the accelerator acceleration Gac reaches the requested acceleration Gd_L2, that is, from time t1 to time t2 in FIG. 8, the accelerator acceleration Gac is greater than or equal to the requested acceleration Gd. Thus, the powertrain device 71 is controlled to achieve the accelerator acceleration Gac. Consequently, the current acceleration Gcu_L1 matches the accelerator acceleration Gac.

In the present embodiment, when the accelerator acceleration Gac decreases, the current acceleration Gcu matches the accelerator acceleration Gac. Accordingly, an acceleration greater than the accelerator acceleration Gac or the requested acceleration Gd does not occur. Thus, the generation of unnecessary driving force is prevented.

### Comparison Between the Present Embodiment and Third Comparative Example

The third comparative example will now be described. As a prerequisite for the third comparative example, the requested acceleration Gd is the acceleration acting in the braking direction of the vehicle 100. The requested acceleration Gd is greater than or equal to the current acceleration Gcu. That is, the braking force obtained at the current acceleration Gcu is greater than the braking force obtained at the requested acceleration Gd. In the third comparative example, the initial acceleration Gsp is set to the current acceleration Gcu. In this regard, the third comparative example differs from the present embodiment.

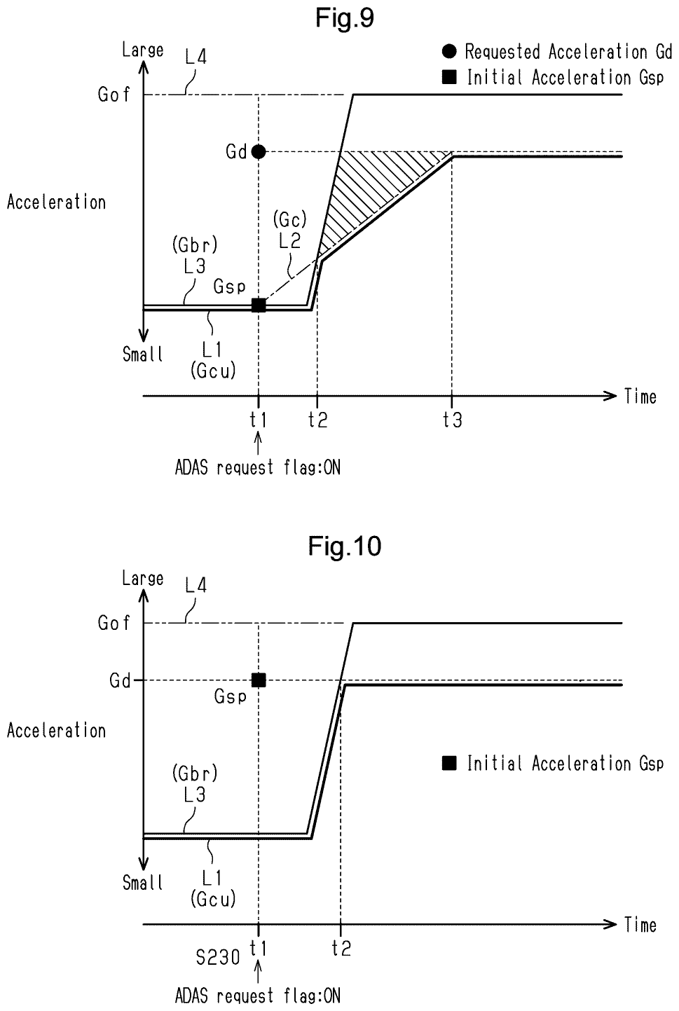

FIG. 9 is a diagram illustrating an example of the changes in acceleration in the third comparative example. The solid line L1 shown in FIG. 9 indicates the current acceleration Gcu. The single-dashed line L2 indicates the transition acceleration Gc. The solid line L3 indicates the braking acceleration Gbr. The double-dashed line L4 indicates the accelerator-off acceleration Gof. Subsequent to time t3 shown in FIG. 9, the transition acceleration Gc_L2 reaches the requested acceleration Gd. Therefore, the current acceleration Gcu_L1 is controlled to match the requested acceleration Gd.

In the third comparative example, at time t1, the ADAS request flag is turned ON, resulting in the calculation of the requested acceleration Gd. The current acceleration Gcu_L1 at time t1 is substituted into the initial acceleration Gsp. The transition acceleration Gc_L2 is generated from the initial acceleration Gsp toward the requested acceleration Gd.

At a certain point after time t1, for example, when the driver releases the brake pedal, the requested braking force decreases. Consequently, a braking acceleration Gbr_L3 increases toward the accelerator-off acceleration Gof_L4.

The following will describe how the braking acceleration Gbr increases. During the period when the accelerator acceleration Gbr_L3 is less than or equal to the transition acceleration Gc_L2, that is, from time t1 to time t2, the brake device 73 is controlled to obtain the braking acceleration Gbr_L3. Therefore, the current acceleration Gcu_L1 matches the braking acceleration Gbr_L3.

The following will further describe how the braking acceleration Gbr increases. During the period when the accelerator acceleration Gbr_L3 is greater than the transition acceleration Gc_L2, that is, from time t2 to time t3, the brake device 73 is controlled to obtain the transition acceleration Gc_L2. Thus, the current acceleration Gcu_L1 matches the transition acceleration Gc_L2. During the period from time t2 to time t3, when the brake device 73 is controlled to obtain the transition acceleration Gc_L2, a braking acceleration is generated with an absolute value greater than the absolute value of the braking acceleration Gbr or the absolute value of the requested acceleration Gd despite the requested braking force decreasing. Therefore, in the third comparative example, an unnecessary braking force is generated.

The present embodiment will now be described.

FIG. 10 illustrates the changes in acceleration in the present embodiment under the same prerequisite as that in the third comparative example. The values indicated by the solid line L1, the solid line L3, and the double-dashed line L4 shown in FIG. 10 are identical to those in FIG. 9.

In the present embodiment, the same prerequisite as that in the third comparative example is satisfied. That is, the requested acceleration Gd is the acceleration acting in the braking direction of the vehicle 100. The requested acceleration Gd is greater than or equal to the current acceleration Gcu. In this case, the process of S100 shown in FIG. 3 results in a negative determination. Since the process of S210 results in an affirmative determination, the motion manager 45 executes the process of S230. Thus, the motion manager 45 substitutes the requested acceleration Gd into the initial acceleration Gsp. That is, in FIG. 10, the black square indicating the initial acceleration Gsp overlaps the black circle indicating the requested acceleration Gd. As a result, in FIG. 10, the black circle indicating the requested acceleration Gd is hidden by the black square indicating the initial acceleration Gsp.

Once the initial acceleration Gsp is determined, the motion manager 45 executes the processes shown in FIG. 4. That is, in step S320 of the present process, the requested acceleration Gd is substituted as the initial value of the transition acceleration Gc. When the present process is executed next time, an affirmative determination will be made in step S340. As a result, the present process ends without executing the process of S350. In other words, the transition acceleration Gc, which connects the initial acceleration Gsp to the requested acceleration Gd, is not substantially generated. Thus, L2 is not illustrated in FIG. 10.

Therefore, as shown in FIG. 10, at a certain point after time t1, the requested braking force decreases. Consequently, the braking acceleration Gbr_L3 increases toward the accelerator-off acceleration Gof_L4.

When the braking acceleration Gbr increases, the transition acceleration Gc is not generated. Accordingly, during the period when the braking acceleration Gbr reaches the requested acceleration Gd_L2, that is, from time t1 to time t2 in FIG. 10, the braking acceleration Gbr_L3 is less than or equal to the requested acceleration Gd. Thus, the brake device 73 is controlled to obtain the braking acceleration Gbr_L3. As a result, the current acceleration Gcu_L1 matches the braking acceleration Gbr_L3.

In the present embodiment, when the braking acceleration Gbr_L3 increases, the current acceleration Gcu_L1 matches the braking acceleration Gbr_L3. This produces no braking acceleration with an absolute value that is greater than the absolute value of the braking acceleration Gbr or the absolute value of the requested acceleration Gd. Thus, the generation of unnecessary braking force is prevented.

### Comparison Between the Present Embodiment and Fourth Comparative Example

The fourth comparative example will now be described. As a prerequisite for the fourth comparative example, the requested acceleration Gd is the acceleration acting in the driving direction. The current acceleration Gcu of the vehicle 100 is the acceleration acting in the braking direction of the vehicle 100. In the fourth comparative example, the initial acceleration Gsp is set to the current acceleration Gcu. In this regard, the fourth comparative example differs from the present embodiment.

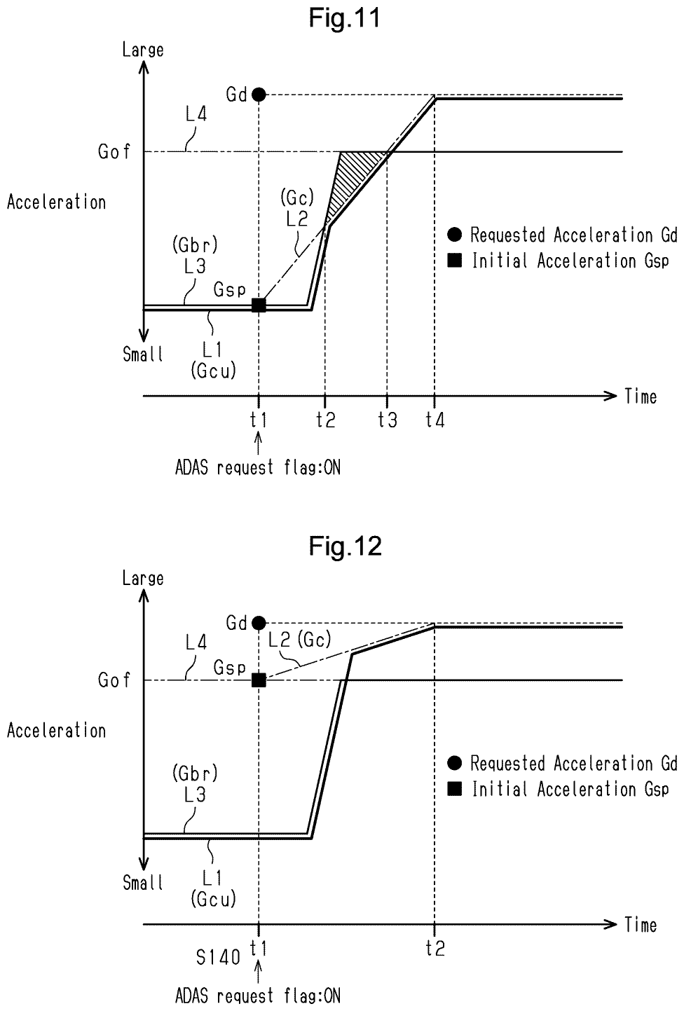

FIG. 11 is a diagram illustrating an example of the changes in acceleration in the fourth comparative example. The solid line L1 shown in FIG. 11 indicates the current acceleration Gcu. The single-dashed line L2 indicates the transition acceleration Gc. The solid line L3 indicates the braking acceleration Gbr. The double-dashed line L4 indicates the accelerator-off acceleration Gof. Subsequent to time t4 shown in FIG. 11, the transition acceleration Gc reaches the requested acceleration Gd. Therefore, the current acceleration Gcu is controlled to match the requested acceleration Gd.

In the fourth comparative example, at time t1, the ADAS request flag is turned ON, resulting in the calculation of the requested acceleration Gd. At time t1, the current acceleration Gcu_L1 is substituted into the initial acceleration Gsp. The transition acceleration Gc_L2 is generated from the initial acceleration Gsp toward the requested acceleration Gd.

At a certain point after time t1, the requested braking force requested from sources other than ADAS control decreases. Consequently, the braking acceleration Gbr_L3 increases toward the accelerator-off acceleration Gof_L4. The requested braking force requested from sources other than ADAS control decreases, for example, when the driver releases the brake pedal back to the non-operation position or when the requested braking force from other braking controls decreases.

The following will describe how the braking acceleration Gbr_L3 increases. During the period when the accelerator acceleration Gbr_L3 is less than or equal to the transition acceleration Gc_L2, that is, prior to time t2, the brake device 73 is controlled to obtain the braking acceleration Gbr_L3. Therefore, the current acceleration Gcu_L1 matches the braking acceleration Gbr_L3.

The following will further describe how the braking acceleration Gbr_L3 increases. During the period when the accelerator acceleration Gbr_L3 is greater than the transition acceleration Gc_L2, that is, from time t2 to time t3, the brake device 73 is controlled to obtain the transition acceleration Gc_L2. Thus, the current acceleration Gcu_L1 matches the transition acceleration Gc_L2. During the period from time t2 to time t3, when the brake device 73 is controlled in this manner, the brake device 73 is controlled to obtain the transition acceleration Gc_L2 despite the requested acceleration Gd from the ADAS control acting in the driving direction. That is, in the fourth comparative example, there may be a risk that the braking control is temporarily executed although a driving request is issued from the ADAS control.

The present embodiment will now be described.

FIG. 12 illustrates the changes in acceleration in the present embodiment under the same prerequisite as that in the fourth comparative example. The values indicated by the solid line L1, the single-dashed line L2, the solid line L3, and the double-dashed line L4 shown in FIG. 12 are identical to those in FIG. 11.

In the present embodiment, the same prerequisite as that in the fourth comparative example is satisfied. That is, the requested acceleration Gd is the acceleration acting in the driving direction. The current acceleration Gcu_L1 is the acceleration acting in the braking direction of the vehicle 100. In this case, the process of S100 shown in FIG. 3 results in an affirmative determination. When the brake pedal is operated, the accelerator pedal is often returned to its non-operation position. Therefore, the requested acceleration Gd often exceeds the accelerator acceleration Gac. Thus, the process of S110 results in a negative determination. Since the current acceleration Gcu_L1 is the acceleration acting in the braking direction of the vehicle 100, the process of step S120 results in an affirmative determination. Accordingly, the motion manager 45 executes the process of step S140. Thus, the motion manager 45 substitutes the accelerator-off acceleration Gof into the initial acceleration Gsp.

Once the initial acceleration Gsp is determined, the motion manager 45 executes the process shown in FIG. 4. That is, in step S320 of the present process, the accelerator-off acceleration Gof is substituted as the initial value of the transition acceleration Gc_L2. The transition acceleration Gc_L2 is generated until the transition acceleration Gc_L2 reaches the requested acceleration Gd.

Therefore, as shown in FIG. 12, after time t1, the braking acceleration Gbr_L3 increases. During the period until the current acceleration Gcu_L1 reaches the requested acceleration Gd at time t2, there is no period during which the braking acceleration Gbr_L3 is greater than the transition acceleration Gc_L2. Therefore, unlike the fourth comparative example, the present embodiment reduces the inconvenience that occurs when the braking control is temporarily executed through the ADAS control although a driving request is issued through the ADAS control.

### Comparison Between the Present Embodiment and Fifth Comparative Example

The fifth comparative example will now be described. As a prerequisite for the fifth comparative example, the requested acceleration Gd is the acceleration acting in the braking direction of the vehicle 100. The current acceleration Gcu of the vehicle 100 is the acceleration acting in the driving direction. In the fifth comparative example, the initial acceleration Gsp is set to the current acceleration Gcu. In this regard, the fifth comparative example differs from the present embodiment.

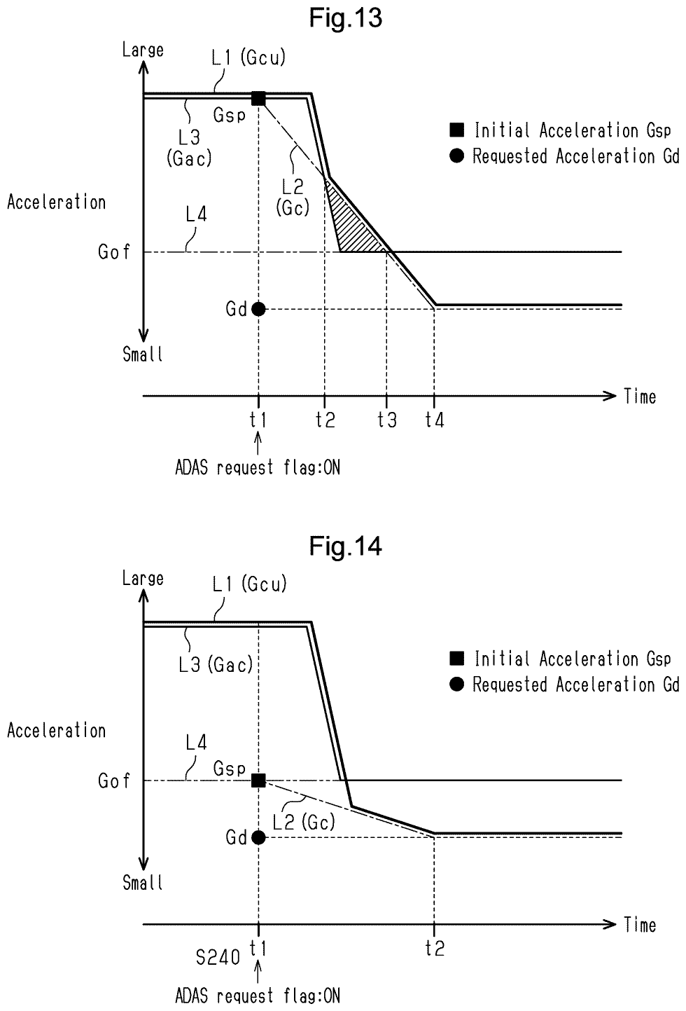

FIG. 13 is a diagram illustrating an example of the changes in acceleration in the fifth comparative example. The solid line L1 shown in FIG. 13 indicates the current acceleration Gcu. The single-dashed line L2 indicates the transition acceleration Gc. The solid line L3 indicates the accelerator acceleration Gac. The double-dashed line L4 indicates the accelerator-off acceleration Gof. Subsequent to time t4 shown in FIG. 13, the transition acceleration Gc_L2 reaches the requested acceleration Gd. Therefore, the current acceleration Gcu is controlled to match the requested acceleration Gd.

In the fifth comparative example, at time t1, the ADAS request flag is turned ON, resulting in the calculation of the requested acceleration Gd. The current acceleration Gcu_L1 at time t1 is substituted into the initial acceleration Gsp. The transition acceleration Gc_L2 is generated from the initial acceleration Gsp toward the requested acceleration Gd.

At a certain point after time t1, when the driver returns the accelerator pedal to the non-operation position, the accelerator acceleration Gac_L3 decreases toward the accelerator-off acceleration Gof_L4.

When the accelerator acceleration Gac decreases, during the period when the accelerator acceleration Gac is greater than or equal to the transition acceleration Gc_L2, that is, prior to time t2, the powertrain device 71 is controlled to obtain the accelerator acceleration Gac. Thus, the current acceleration Gcu_L1 matches the accelerator acceleration Gac.

When the accelerator acceleration Gac decreases, during the period when the accelerator acceleration Gac is less than the transition acceleration Gc_L2, that is, from time t2 to time t3, the powertrain device 71 is controlled to obtain the transition acceleration Gc. Thus, the current acceleration Gcu_L1 matches the transition acceleration Gc. During the period from time t2 to time t3, when the powertrain device 71 is controlled in this manner, the powertrain device 71 is controlled to obtain the transition acceleration Gc despite the requested acceleration Gd from the ADAS control acting in the braking direction of the vehicle 100. That is, in the fifth comparative example, there may be a risk that the driving control is temporarily executed although a braking request is issued from the ADAS control.

The present embodiment will now be described.

FIG. 14 illustrates the changes in acceleration in the present embodiment under the same prerequisite as that in the fifth comparative example. The values indicated by the solid line L1, the single-dashed line L2, the solid line L3, and the double-dashed line L4 shown in FIG. 14 are identical to those in FIG. 13.

In the present embodiment, the same prerequisite as that in the fifth comparative example is satisfied. That is, the requested acceleration Gd is the acceleration acting in the braking direction of the vehicle 100. The current acceleration Gcu is the acceleration acting in the driving direction. In this case, the process of S100 shown in FIG. 3 results in a negative determination. The requested acceleration Gd is the acceleration acting in the braking direction of the vehicle 100. Further, when the current acceleration Gcu is the acceleration in the driving direction, the requested acceleration Gd is smaller than the current acceleration Gcu. The process of S210 results in a negative determination. Since the current acceleration Gcu is the acceleration acting in the driving direction of the vehicle 100, the process of step S220 results in an affirmative determination. Accordingly, the motion manager 45 executes the process of step S240. Thus, the motion manager 45 substitutes the accelerator-off acceleration Gof into the initial acceleration Gsp.

Once the initial acceleration Gsp is determined, the motion manager 45 executes the process shown in FIG. 4. That is, in step S320 of the present process, the accelerator-off acceleration Gof is substituted as the initial value of the transition acceleration Gc. The transition acceleration Gc is generated until the transition acceleration Gc reaches the requested acceleration Gd.

Therefore, as shown in FIG. 14, after time t1, the accelerator acceleration Gac_L3 decreases. During the period until time t2, when the current acceleration Gcu_L1 reaches the requested acceleration Gd, there is no period during which the accelerator acceleration Gac is less than the transition acceleration Gc_L2. During the period until the accelerator acceleration Gac_L3 decreases and then the current acceleration Gcu_L1 reaches the requested acceleration Gd, that is, from time t1 to time t2, there is no period during which the accelerator acceleration Gac is less than the transition acceleration Gc_L2. Therefore, unlike the fifth comparative example, the present embodiment reduces the inconvenience that occurs when the driving control is temporarily executed although a braking request is issued from the ADAS control.

### Advantages of the Present Embodiment

(1) The motion manager 45 receives the requested acceleration Gd from the driver-assistance system (50) of the vehicle 100. The motion manager 45 determines the initial acceleration Gsp. The initial acceleration Gsp is the starting point for modifying the vehicle acceleration (Gcu) toward the requested acceleration Gd. The motion manager 45 generates the transition acceleration Gc, which connects the initial acceleration Gsp to the requested acceleration Gd. Based on the transition acceleration Gc, the motion manager 45 outputs instruction signals to control the actuators 71 to 73 of the vehicle 100.

Accordingly, the initial acceleration Gsp is determined by the motion manager 45, rather than the driver-assistance system (50). Thus, as described in the section Comparison Between the Present Embodiment and First Comparative Example with reference to FIGS. 5 and 6, the above-described configuration reduces the deviation ER between the current value of the accelerator-off acceleration Gof recognized by the motion manager 45 and the current value of the accelerator-off acceleration Gof recognized by the advanced driver-assistance unit 50S. This allows for proper setting of the initial acceleration Gsp for achieving the requested acceleration Gd that has been received from the driver-assistance system.

Properly setting the initial acceleration Gsp reduces the risk described in the section Comparison Between the Present Embodiment and First Comparative Example, which is indicated by FIGS. 5 and 6. Therefore, when the driving force is increased, the braking force is prevented from being temporarily generated. Thus, the sense of discomfort is prevented from being experienced by the driver. Properly setting the initial acceleration Gsp also prevents the driving force from being temporally generated when the braking force is increased. This also prevents the sense of discomfort from being experienced by the driver.

(2) As shown in FIG. 4, the motion manager 45 acquires the acceleration change rate Ger, which is used to modify the vehicle acceleration toward the requested acceleration Gd, from the driver-assistance system. The motion manager 45 generates the transition acceleration Gc based on the acceleration change rate Gcr. Accordingly, the transition acceleration Gc is properly generated so as to start from the initial acceleration Gsp determined by the motion manager 45.

(3) The brake ECU 40, which serves as the motion manager 45, and the advanced driver-assistance ECU 50, which is included in the driver-assistance system, are connected to each other via external buses (63, 64) for mutual communication. In this configuration, for example, compared to a configuration in which the brake ECU and the advanced driver-assistance ECU 50 are connected to each other for mutual communication via an internal bus, the above-described communication latency tends to be larger. Thus, the above-described inconvenience resulting from the communication latency is more likely to occur. In the present embodiment, the motion manager 45 determines the initial acceleration Gsp. This reduces the inconvenience described in the section Comparison Between the Present Embodiment and First Comparative Example, which is indicated by FIGS. 5 and 6.

(4) When the requested acceleration Gd acts in the driving direction and the requested acceleration Gd is less than or equal to the accelerator acceleration Gac, the motion manager 45 executes the process that substitutes the requested acceleration Gd into the initial acceleration Gsp without generating the transition acceleration Gc. The accelerator acceleration Gac is determined from the amount of operation applied to the accelerator pedal by the driver.

Therefore, the risk described in the section Comparison Between the Present Embodiment and Second Comparative Example, which is indicated by FIGS. 7 and 8, is reduced. That is, this limits situations in which an acceleration greater than the accelerator acceleration Gac or the requested acceleration Gd occurs even though the driver has returned the accelerator pedal to the non-operation position. Thus, the generation of unnecessary driving force is prevented.

(5) When the requested acceleration Gd acts in the braking direction of the vehicle 100 and the requested acceleration Gd is greater than or equal to the acceleration acting on the vehicle 100 in the braking direction, the motion manager 45 executes the process that substitutes the requested acceleration Gd into the initial acceleration Gsp without generating the transition acceleration Gc.

Therefore, the inconvenience described in the section Comparison Between the Present Embodiment and Third Comparative Example, which is indicated by FIGS. 9 and 10, is limited. The inconvenience is that a braking acceleration is produced with an absolute value that is greater than the absolute value of the braking acceleration Gbr or the absolute value of the requested acceleration Gd even though the requested braking force decreases. Thus, the generation of unnecessary braking force is prevented.

(6) The motion manager 45 calculates the accelerator-off acceleration Gof. The accelerator-off acceleration Gof is the vehicle acceleration when the accelerator pedal operated by the driver is released. When the requested acceleration Gd acts in the driving direction and the vehicle acceleration acts in the braking direction of the vehicle 100, the motion manager 45 executes the process that substitutes the accelerator-off acceleration Gof into the initial acceleration Gsp.

Therefore, the inconvenience described in the section Comparison Between the Present Embodiment and Fourth Comparative Example, which is indicated by FIGS. 11 and 12, is limited. That is, this configuration limits situations in which the braking control is temporarily executed through the ADAS control although a driving request is issued through the ADAS control.

(7) The motion manager 45 calculates the accelerator-off acceleration Gof. The accelerator-off acceleration Gof is the vehicle acceleration when the accelerator pedal operated by the driver is released. When the requested acceleration Gd acts in the braking direction of the vehicle 100 and the vehicle acceleration acts in the driving direction, the motion manager 45 substitutes the accelerator-off acceleration Gof into the initial acceleration Gsp.

Therefore, the inconvenience described in the section Comparison Between the Present Embodiment and Fifth Comparative Example, which is indicated by FIGS. 13 and 14, is limited. That is, this configuration limits situations in which the driving control is temporarily executed through the ADAS control although a braking request is issued from the ADAS control.

### Modifications

The present embodiment may be modified as described below. The present embodiment and the following modifications can be combined as long as the combined modifications remain technically consistent with each other.

Instead of the advanced driver-assistance unit 50S, the motion manager 45 may calculate the acceleration change rate Gcr.

Instead of the advanced driver-assistance unit 50S, the motion manager 45 may include the preliminary arbitration unit 53.

The motion manager 45 and the advanced driver-assistance unit 50S may be connected to each other for mutual communication via an internal bus.

At least one of the processes S130, S140, S230, and S240 illustrated in FIG. 3 may be omitted. In this specification, the phrase “at least one of” means “one or more” of a desired choice. For example, the phrase “at least one of” as used in this description means “only one choice” or “both of two choices” if the number of choices is two. In another example, the phrase “at least one of” as used in this description means “only one single choice” or “any combination of two or more choices” if the number of its choices is three or more.

At least one of the processes S150 and S250 shown in FIG. 3 may be omitted.

The ECU that enables the functions of the motion manager 45 is not limited to the brake ECU 40. For example, instead of the brake ECU 40, the central processing device 11 of the central ECU 10 may enable the functions of the motion manager 45. The central processing device 11 can enable the functions of the motion manager 45 by executing the motion manager app 45A, which is stored in the central storage device 12. The central ECU 10, the powertrain ECU 20, the steering ECU 30, the brake ECU 40, and the advanced driver-assistance ECU 50 may each be employed as the control device.

The control device only needs to include a CPU and a ROM and execute software processing. The control device is not limited to this configuration. That is, the control device may be modified as long as it has any one of the following configurations (a) to (c).
(a) The control device includes one or more processors that execute various processes in accordance with a computer program. The processor includes a CPU and a memory, such as a RAM and a ROM. The memory stores program codes or commands (e.g., information providing process) that are configured to have the CPU execute a process. The memory, or a non-transitory computer-readable storage medium, includes any type of media that are accessible by general-purpose computers and dedicated computers.
(b) The control device includes one or more dedicated hardware circuits that execute various processes. Examples of the dedicated hardware circuits include an application-specific integrated circuit (ASIC) and a field-programmable gate array (FPGA).
(c) The control device includes a processor that executes part of various processes in accordance with a computer program and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A control device for a vehicle, the control device comprising processing circuitry configured to:
receive a requested acceleration from a driver-assistance system of the vehicle;
determine an initial acceleration, wherein the initial acceleration is a starting point for modifying a vehicle acceleration toward the requested acceleration;
generate a transition acceleration that connects the initial acceleration to the requested acceleration; and
output, based on the transition acceleration, an instruction signal that is used to control an actuator of the vehicle.

2. The control device for the vehicle according to claim 1, wherein
the processing circuitry is configured to:
acquire a change rate of the vehicle acceleration that is used to modify the vehicle acceleration toward the requested acceleration; and
generate the transition acceleration based on the change rate.

3. The control device for the vehicle according to claim 1, wherein
the control device and an other control device that is included in the driver-assistance system are connected to each other for mutual communication via an external bus.

4. The control device for the vehicle according to claim 1, wherein
an accelerator pedal is operated by a driver of the vehicle,
an accelerator acceleration is determined from an operation amount of the accelerator pedal, and
the processing circuitry is configured to substitute the requested acceleration into the initial acceleration without generating the transition acceleration when the requested acceleration is an acceleration that acts in a driving direction of the vehicle and the requested acceleration is less than or equal to the accelerator acceleration.

5. The control device for the vehicle according to claim 1, wherein
the processing circuitry is configured to substitute the requested acceleration into the initial acceleration without generating the transition acceleration when the requested acceleration is an acceleration that acts in a braking direction of the vehicle and the requested acceleration is greater than or equal to the acceleration that acts in the braking direction of the vehicle.

6. The control device for the vehicle according to claim 1, wherein
an accelerator pedal is operated by a driver of the vehicle, and
the processing circuitry is configured to:
calculate an accelerator-off acceleration, wherein the accelerator-off acceleration is the vehicle acceleration when the accelerator pedal is released; and
substitute the accelerator-off acceleration into the initial acceleration when the requested acceleration is an acceleration that acts in a driving direction of the vehicle and the vehicle acceleration is an acceleration that acts in a braking direction of the vehicle.

7. The control device for the vehicle according to claim 1, wherein
an accelerator pedal is operated by a driver of the vehicle, and
the processing circuitry is configured to:
calculate an accelerator-off acceleration, wherein the accelerator-off acceleration is the vehicle acceleration when the accelerator pedal is released; and
substitute the accelerator-off acceleration into the initial acceleration when the requested acceleration is an acceleration that acts in a braking direction of the vehicle and the vehicle acceleration is an acceleration that acts in a driving direction of the vehicle.

8. A non-transitory computer-readable storage medium that stores a program for causing a processing device to execute a control process, the control process comprising:
receiving a requested acceleration from a driver-assistance system of the vehicle;
determining an initial acceleration, wherein the initial acceleration is a starting point for modifying a vehicle acceleration toward the requested acceleration;
generating a transition acceleration that connects the initial acceleration to the requested acceleration; and
outputting, based on the transition acceleration, an instruction signal that is used to control an actuator of the vehicle.

9. A control method executed by a control device that includes processing circuitry, the control method comprising:
receiving, by the processing circuitry, a requested acceleration from a driver-assistance system of the vehicle;
determining, by the processing circuitry, an initial acceleration, wherein the initial acceleration is a starting point for modifying a vehicle acceleration toward the requested acceleration;
generating, by the processing circuitry, a transition acceleration that connects the initial acceleration to the requested acceleration; and
outputting, by the processing circuitry, based on the transition acceleration, an instruction signal that is used to control an actuator of the vehicle.
